(19) United States
(12) Patent Application Publication
(10) Pub. No.: US 2014/0060341 A1
(43) Pub. Date: Mar. 6, 2014

(54) Wiener Stringz 2 in 1 Cutter Roaster

(71) Applicant: Lisa Lynn Runstedler, Dashwood (CA)

(72) Inventor: Lisa Lynn Runstedler, Dashwood (CA)

(21) Appl. No.: 13/601,954

(22) Filed: Aug. 31, 2012

(51) Int. Cl. A47J 37/04

(52) U.S. Cl. 99/419

(57) ABSTRACT

This 2 in 1 cutter roaster device is for the purpose of cutting and roasting a food item such as a wiener or sausage by simply inserting it through the cutter blades attached to the roasting fork eliminating the use of the common knife. Cook the food item while it remains lodged between the blades or simply cut the wiener by inserting it through the blades then remove the wiener and place it on the roasting forks to create exciting shapes like an octopus or crab.

### BACKGROUND AND SUMMARY OF THE INVENTION

The present invention is a cooking apparatus for roasting wieners or sausages over a source of heat or flame like a bonfire. This hotdog fork is made unique by its built in cutting devices which have blades to cut lengthwise through food products like a wiener and create shapes like long or short meat strips without the user ever needing a knife. While feeding the wiener shaped meat product through these blades the wiener shaped product takes on a shape of four long strips instead of its usual single solid structure. Push the wiener through the blade device so that only a 1″ piece remains uncut and sits on the blade surrounded by the wiener feed guide ring above the cutter blades. While cooking the meat product over a heat source the wiener strips cook and curl around the blades to form string shaped pieces of meat. After the wiener or sausage is cooked simply push the remaining 1″ uncut piece through the blades onto a plate. The wiener now takes on the appearance of four thin strips of wiener or sausage rather than the usual wiener shape . . . an exciting snack for the family. The built in cutting device may also be used in place of a knife to cut the end of a long meat product or wiener then placed on the roasting fork to roast into shapes like an octopus. With the cutter disks blades being a part of the cooking apparatus the blades never need to be washed. Simply burn them clean after each use. Bring the Roasting fork down to size by loosening the main shaft tension knob for easy compact storage.

The present invention is convenient to use, eliminates the common kitchen knife and allows you the ability to cut meat products such as a wiener by feeding it through the cutter disk blades which are built into a standard fire roasting fork. It is a durable and effective implement for roasting food over an open heat source such as a campfire and transforming the standard wiener into an array of various creations and unique Hot Dogs.

If you choose, the wiener may be cut into smaller lengths and pushed into the cutter disk blades to create smaller bite size snacks.

The blades are only sharp enough to cut a wiener or sausage product and are not sharp enough to cut a finger . . . made this way for safety of the user.

In addition to the features and advantages mentioned above, other objects and advantages of the 2 in 1 cutter roaster will be readily apparent from the following descriptions of the drawings and preferred embodiments.

### TECHNICAL FIELD

The 2 in 1 cutter roaster relates generally to culinary tools. More particularly to a novel and improved roasting implements intended for use in the cutting and roasting of wieners, sausages, hot dogs and frankfurters over an open fire to transform the shape of a standard wiener and such.

### BACKGROUND ART

Traditionally, a metal camp fork is used by campers for roasting a hot dog, sausage or the like over a campfire during cooking. The hot dog is slid on the metal fork and positioned immediately over the fire so that the heat of the fire cooks the food.

One shortcoming to the use of ordinary camp forks is that without a knife to cut the wiener, you will always have the same looking wiener. With this invention of the said “2 in 1 cutter roaster”, campers will no longer be required to have a knife handy, they can simply use the built in cutting device to cut the ends of the wiener or sausage then roast them into interesting shapes that resemble the octopus or crab, which makes eating these tasty treats much more desirable to children. The wiener or sausage can also be left part way in the cutter blades then roasted to create long strings of meat for a tasty treat.

In the past, various patents have been issued relating to the roasting of hot dogs and other food items over an open campfire, but in my extensive search I have found that no other wiener roasting device is comprised with a built in cutting device of any kind.

### BRIEF DESCRIPTION OF THE DRAWINGS

FIG. 1 is a perspective view of an embodiment of the present invention.

FIG. 2 is a front view of an embodiment of the main telescopic shaft of the present invention.

FIG. 3 is a front view of an embodiment of the handle of the present invention.

FIG. 4 is a front view of the tension knob for the main telescopic shaft of the present invention.

FIG. 5 is a front view of an embodiment of a set of 2 wiener feed guide rings welded atop a set of 2 cutter disk blades of the present invention.

FIG. 6 is a side view of the wiener feed guide ring of the present invention.

FIG. 7 is a side view of the cutter disk blades of the present invention.

FIG. 8 is a top view of the wiener feed guide ring welded on top of the cutter disk blade below of the present invention.

FIG. 9 is a side view of the top wiener feed guide ring welded to the lower cutter disk blade of the present invention.

FIG. 10 is a side angle view of the 3 metal roaster forks of the present invention.

FIG. 11 is a front view of an embodiment of the 2 wiener feed guide rings welded on top of the 2 cutter disk blades of the present invention.

FIG. 12 is the side view of the long strips of wiener after being inserted into the cutter disk blades and being roasted over a bonfire

FIG. 13 is the side view of the top 1″ uncut portion of the wiener sitting in the wiener feed guide ring.

### DETAILED DESCRIPTION OF THE EXEMPLARY EMBODIMENT(S)

The present invention relates to a metal apparatus for cooking food over a heat source with built in cutting disks used to cut the food conveniently into skinny lengthwise strips FIG. 12 by sliding a standard shaped wiener into the wiener feed guide FIG. 6 and through the attached FIG. 9 cutter disk blades FIG. 7 which are attached to the wiener roaster FIG. 11. The main shaft FIG. 2 is to be of a length adequate to allow a user to stand comfortably away from an open heat source, such as a camp fire, while cooking a food FIG. 12 held in the cutter disk blades FIG. 7 with the top 1″ portion FIG. 13 remaining in the wiener feed guide ring FIG. 6 or choose to cook it on the forks FIG. 10 over the open heat source. The main shaft FIG. 2 is to be telescopic so that the shaft can be made shorter for greater leverage control when pushing the food through the blade or longer to prevent the user from getting too close to the heat. The main Shaft will extend or compact by loosening or tightening the attached tension knob FIG. 4 located in the middle of the shaft.

These cutter disk blades FIG. 11 in combination with a conventional wiener roaster makes this a unique favorite for outdoor lovers and bonfire fans that can create a large assortment of tasty treats in various shapes and sizes. You may also choose to create a variety of designer wieners by pushing the wiener only part way through the cutter disk blades then pulling it back out of the blades and placing it on the fork portion FIG. 10 of the roaster to cook into shapes like an octopus. As shown in the example embodiments, with the possible exception of the handle FIG. 3, a metal such as stainless steel is a preferred material for the construction of the present invention. Other metals, including alloys typically used for cooking food may also be used as a material for the construction of the present invention. Typically, the handle FIG. 3 will be made of a heat insulating or non-heat conductive material for the comfort of the user. Wood, plastic, and compositions thereof are usable as a handle FIG. 3 of the present invention, although typical heat dispersing designs such as a metal wire handle may be used.

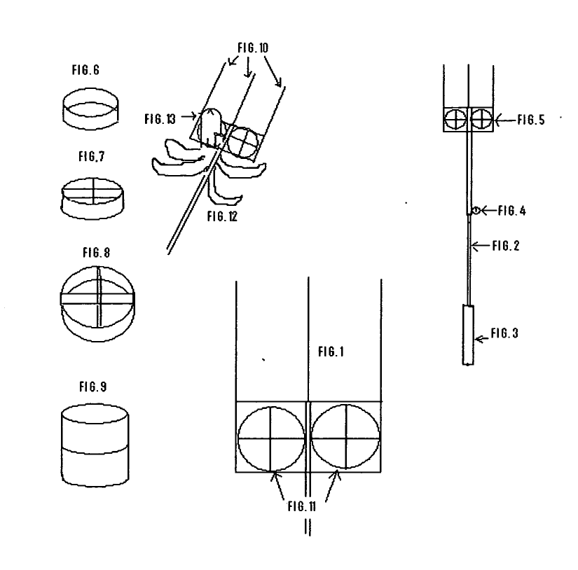

The present invention is used as a cooking apparatus in combination with a cutting apparatus “2 in 1 cutter roaster” for use to cook food over an open heat source like a camp fire. This unique design eliminates the use of sharp knives. Simply feed the Wiener like product into the wiener feed guide ring and through the center of the cross shaped cutter blade apparatus FIG. 8 and if you choose to make string like wiener shapes FIG. 12 simply leave a 1″ portion of the Wiener or sausage FIG. 13 uncut within the guide ring FIG. 6. The cut portion of the wiener will remain lodged within the blades. The blade will hold the long wiener strips in place while they dangle from the base of the cutter blades FIG. 12 while roasting the wiener or sausage strips over an open heat source such as a fire. The heat will curl the ends outward FIG. 12 preventing the wiener from falling off when rotated. You may also use the cutter disc blades to simply cut the wiener by inserting it into the feed guide ring and through the cross shaped cutter disc blades FIG. 8 & then pulling the wiener back out of the cross shaped blades and roasting it on the Fork portion FIG. 10 of the cooking apparatus FIG. 1. Typical foods for use with the present invention include hot dogs, wieners, sausages and bratwurst.

I claim:

1. A 2 in 1 device for cutting and roasting a food item comprising:
a)A telescopic shaft with a tension knob;
b)one sets of metal cutting blade discs each with a wiener feed guide ring attached to the top of the blade disc to guide the wiener into the center of the cross shaped blade. These formed at one end of said shaft;
c) three forks formed connecting two cutting blade discs of said shaft; and
d) A handle affixed to an end of said shaft opposite said cutter blades and forks member.

2. The device of claim 1 a, said telescopic shaft made up of two shaft columns in equal length with the upper shaft having a larger diameter so to fit over top of the lower shaft. This will allow the user to compact the main shaft to half the normal size for storage or extend it fully to cook with. The said tension knob located between the upper and lower shafts may be tightened or loosened by hand to adjust the shaft length.

3. The device of claim 1 b, said cutting blades being two blades that cross through each other to form a cross shape design.

4. The device of claim 1 b, said cross shaped metal blades are encompassed by a metal ring disc. This combination forms the said cutting blade discs.

5. The device of claim 1 b, said wiener feed guide ring is situated on top of each cutting blade disc which guides the wiener through to the center of the cross shaped cutting blades.
